(19) United States
(12) Patent Application Publication
(10) Pub. No.: US 2022/0224819 A1
(43) Pub. Date: Jul. 14, 2022

(54) SENSING MODULE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HAI-JUN XU, Kunshan (CN); TUNG-LOU LIN, New Taipei (TW)

(21) Appl. No.: 17/572,815

(22) Filed: Jan. 11, 2022

(30) Foreign Application Priority Data
Jan. 13, 2021 (CN) 202110042411.7

(51) Int. Cl. H04N 5/235; G01B 11/24; H04N 7/015; H04N 5/225; H04N 7/22

(52) U.S. Cl. CPC H04N 5/2354; G01B 11/24; H04N 7/22; H04N 5/2256; H04N 7/015

(57) ABSTRACT

A sensing module includes: a circuit board; a light emitter installed on the circuit board for continuously emitting light waves; a photoelectric converter for converting emitted light waves into electrical signals; a camera; and a controller capable of controlling operation of the camera upon detecting that a foreign object is approaching so that light wave is reflected upon the photoelectric converter to stimulate the controller to start the camera to shoot the foreign object.

### BACKGROUND OF THE INVENTION

### 1. Field of the Invention

The present invention relates generally to a sensing module that can work continuously and has low energy consumption.

### 2. Description of Related Arts

With the increasing popularity of surveillance systems, surveillance cameras are widely used in various fields to protect social security. Taking vehicle parking monitoring as an example, in the current increasingly complex parking environment, vehicle damage often occurs. Therefore, vehicle safety has become a problem that car owners are more concerned about. Installing monitoring systems in parking lots and garages is the most common solution. But the vehicle is not always parked in a monitored environment. If it is parked on the side of a road or outdoors where no surveillance is installed, the safety of the vehicle is difficult to guarantee. In addition, it is more troublesome to obtain public monitoring. At this time, a parking monitoring device is needed to assist in completing the monitoring tasks of the vehicle, so as to protect the legitimate rights and interests of the vehicle owner.

A car may have a feature that allows monitoring of suspicious activities around the car when parked and locked in specified locations. When suspicious motion is detected, the car will react depending on the severity of the threat. Although the traditional monitoring mode can meet some monitoring needs, its work efficiency is limited. During continuous monitoring, a lot of meaningless videos will be recorded; for some important videos covered, a lot of power is consumed, and the camera has been working continuously to an extent affecting its service life.

An improved sensing module is desired.

### SUMMARY OF THE INVENTION

A main object of the present invention is to provide a sensing module that can work continuously and has low energy consumption.

To achieve the above-mentioned object, a sensing module comprises: a circuit board; a light emitter installed on the circuit board for continuously emitting light waves; a photoelectric converter for converting emitted light waves into electrical signals; a camera; and a controller capable of controlling operation of the camera upon detecting that a foreign object is approaching so that light wave is reflected upon the photoelectric converter to stimulate the controller to start the camera to shoot the foreign object.

Compared to prior art, the sensing module senses whether there is a foreign object approaching through the photoelectric converter, and when a foreign object approaches, the controller is then stimulated to start the camera to shoot the foreign object, so that it can continuously and effectively monitor the surrounding environment, and the work energy consumption is lower.

### BRIEF DESCRIPTION OF THE DRAWING

FIG. 1 is a perspective view of a sensing module of the first embodiment in accordance with the present invention;

FIG. 2 is another perspective view of the sensing module in FIG. 1;

FIG. 3 is an exploded view of the sensing module in FIG. 1;

FIG. 4 is another exploded view of the sensing module in FIG. 3;

FIG. 5 is a further exploded view of the sensing module in FIG. 4;

FIG. 6 is a cross-sectional view along line 6-6 of the sensing module in FIG. 1;

FIG. 7 is a cross-sectional view along line 7-7 of the sensing module in FIG. 1;

FIG. 8 is a perspective view of a sensing module of the second embodiment in accordance with the present invention;

FIG. 9 is another perspective view of the sensing module in FIG. 8;

FIG. 10 is another perspective view of the sensing module in FIG. 9; and

FIG. 11 is a cross-sectional view taken along line 11-11 of the electrical connector in FIG. 1.

### DETAILED DESCRIPTION OF THE PREFERRED EMBODIMENT

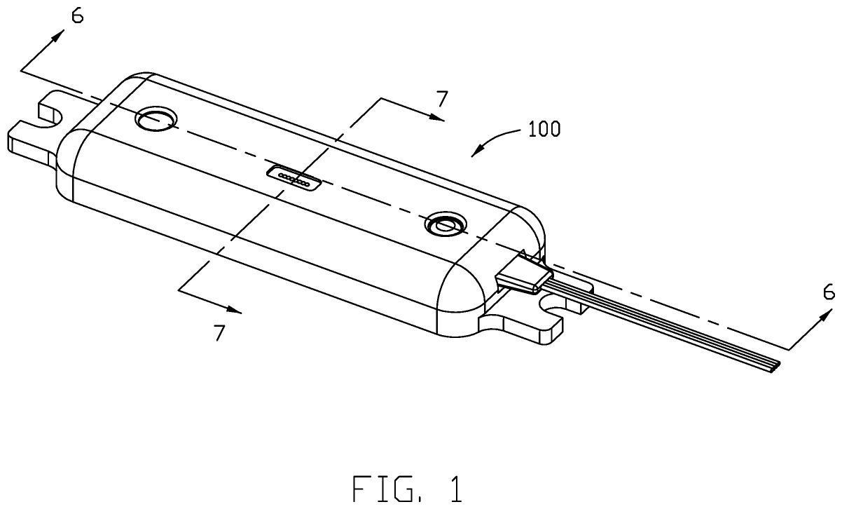

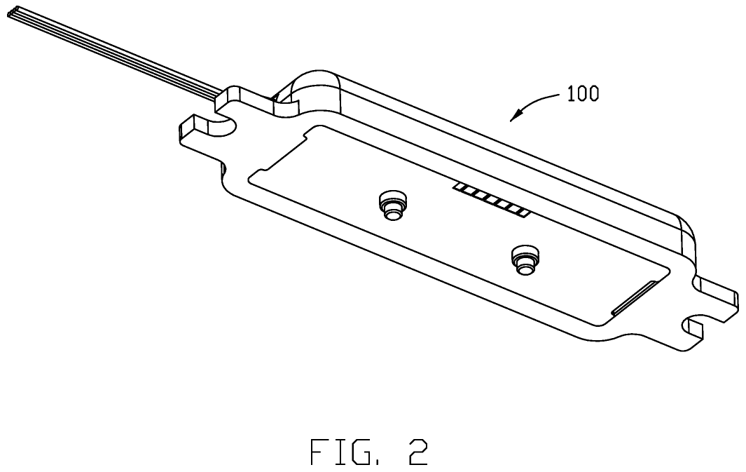

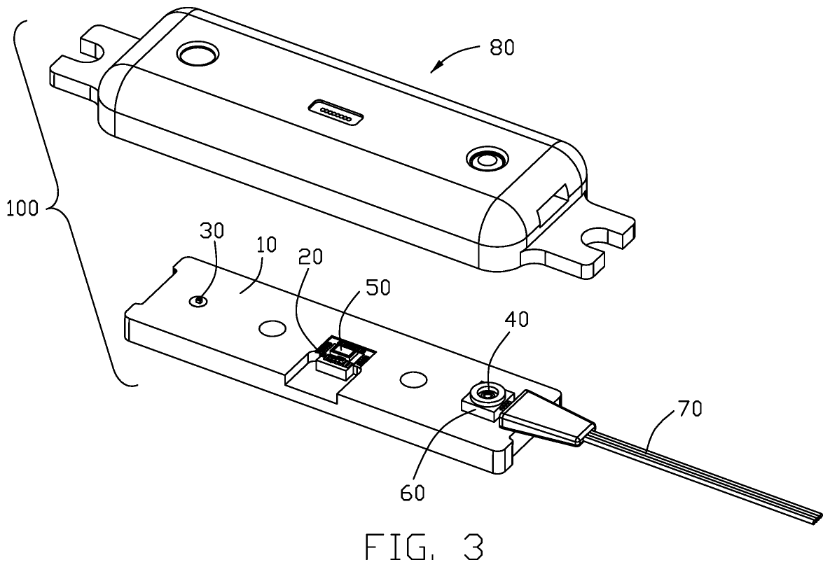

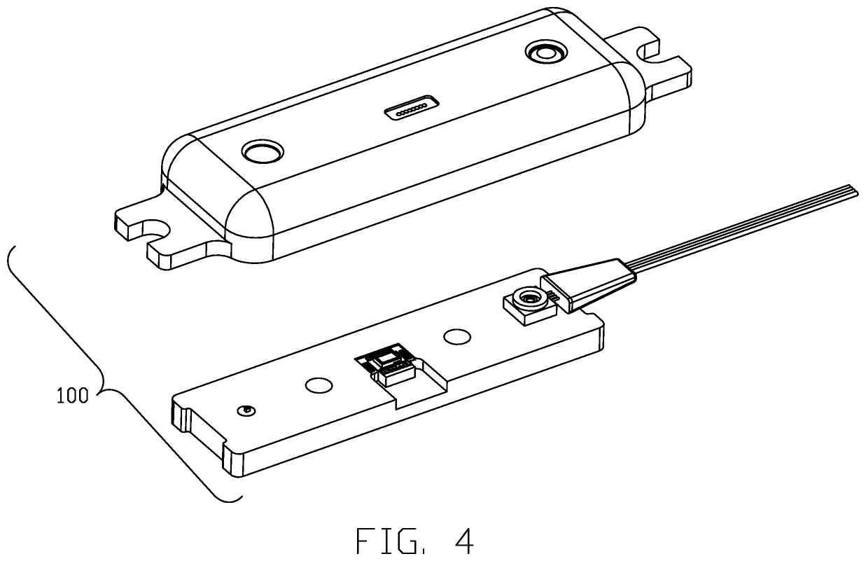

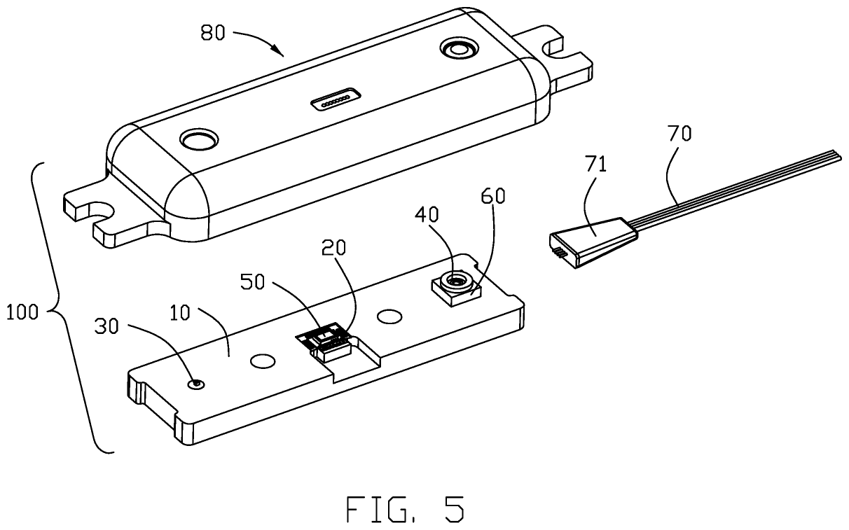

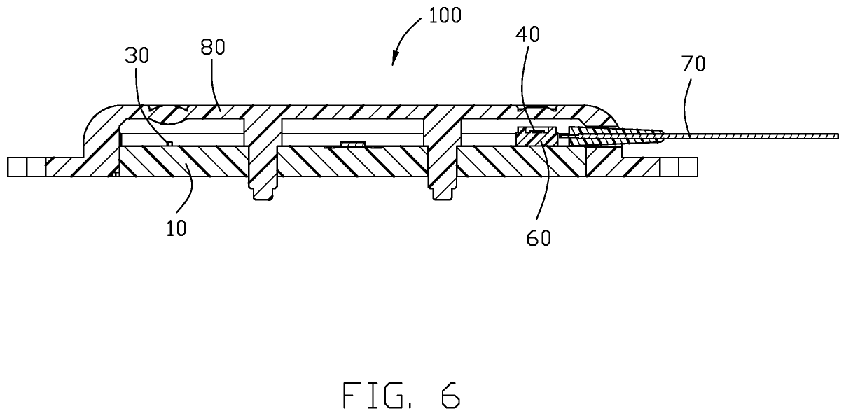

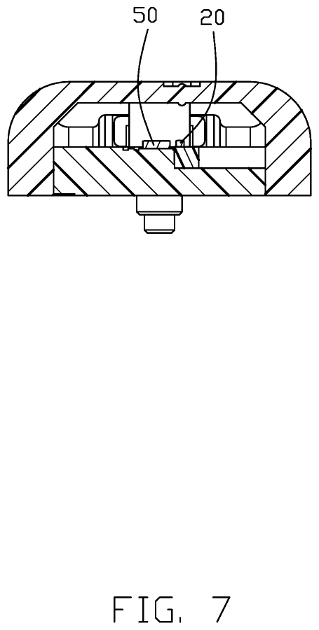

Referring to FIGS. 1-7, the first embodiment of a sensing module 100 in accordance with the present invention is shown. The sensing module 100 can be applied in a parking monitoring system of a vehicle. The sensing module 100 includes a circuit board 10, a light emitter 20 arranged on the circuit board 10, and a photoelectric converter 30 arranged on the circuit board 10, a camera 40 arranged on the circuit board 10, and a controller 50 arranged on the circuit board 10. The light emitter 20 can continuously emits light waves. The photoelectric converter 30 can convert light waves into electrical signals. The controller 50 can control the camera 40 to operate.

The light emitter 20 can continuously emit light waves of a preset specific power. The light wave emitted by the light emitter 20 is laser or other suitable light. The light emitter 20 uses a short-distance laser to perform contour scanning of the approaching foreign objects. Specifically, in the present invention, the wavelength range of the light wave emitted by the light emitter 20 is between 650 nm and 1650 nm, covers the wavelengths of visible light and invisible light. Specifically, in this embodiment, the sensing module 100 can sense foreign objects within approximately 3 meters near the vehicle, when a foreign object approaches, the light waves will be reflected to the photoelectric converter 30, the photoelectric converter 30 can not only detect changes in the surrounding environment of the vehicle according to the received reflected light waves, but also detect the shape of the approaching foreign objects and the distance of the approaching foreign objects based on the light waves reflected to the photoelectric converter 30, and Send an alarm to remind the owner of the vehicle. The working power of the light emitter 20 is less than the working power of the camera 40. The working power of the camera 40 is at least 20 times the working power of the light emitter 20. Specifically, the working power of the light emitter 20 is about tens of milliwatts. The working power of the camera 40 is about a few watts. The camera 40 can support 1K and above shooting. The camera 40 can support 4K or 8K shooting. The light emitter 20 continuously emits light waves. When a foreign object approaches the vehicle, light waves will be reflected to the photoelectric converter 30 to activate the controller 50 to control the camera 40 to shoot the foreign object. The length of the sensing module 100 is approximately 33 mm, the width is approximately 10 mm, and the height is approximately 4 mm. The size of the sensing module 100 is small and requires a small installation space. Multiple sensing modules 100 can be installed on the vehicle to monitor changes in the surrounding environment of the vehicle in an all-round way.

The sensing module 100 further includes a second controller (not shown) for controlling the operation of the light emitter 20. The second controller constantly controls the light emitter 20. The second controller can adjust the strength of the light wave emitted by the light emitter 20 according to the change of the working environment and the working temperature. The second controller can be integrated with the controller 50 as a whole.

The sensing module 100 further includes a converter 60, an optical fiber 70 connected to the converter 60, and a fixing member 71 for fixing the optical fiber 70. The fixing member 71 fixes the optical fiber 70 into a whole. The optical fiber 70 is integrated with the converter 60. The converter 60 converts the content captured by the camera 40 into an optical signal and transmits it through the optical fiber 70. The optical fiber 70 can transmit information to the USB flash memory of the vehicle or the mobile phone of the vehicle owner.

The sensing module 100 further includes a light-transmitting member 80. The light-transmitting member 80 covers the light emitter 20, the photoelectric converter 30, the camera 40 and the controller 50. The light-transmitting member 80 is provided with a spherical lens to realize light collection or astigmatism. The light-transmitting member 80 has good light-transmitting properties, and the light-transmitting member 80 does not hinder the transmission and reception of the light waves, and the shooting of the camera 40. The light-transmitting member 80 may also partially cover the light emitter 20, the photoelectric converter 30, the camera 40, and the controller 50, the part that needs to transmit light or receive light waves is not covered by the light-transmitting member 80, and the light waves propagate directly through the air, or does not require light-transmitting member 80.

In the sensing module 100 of the present invention, the converter 60 is integrated with the camera 40. The content captured by the camera 40 can be directly converted into an optical signal by the converter 60, and then transmitted through the optical fiber 70.

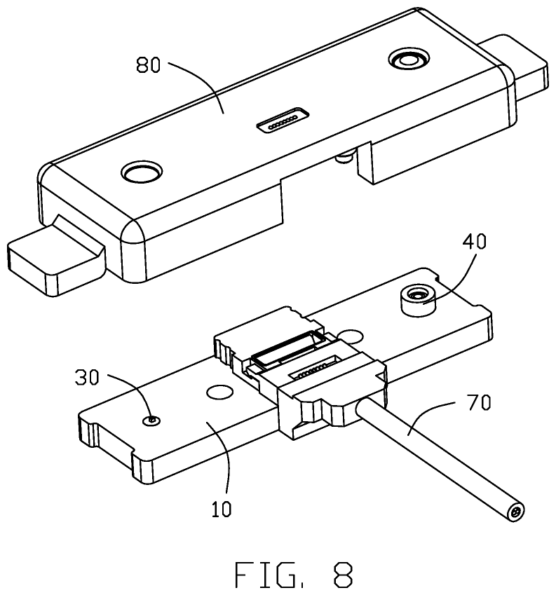

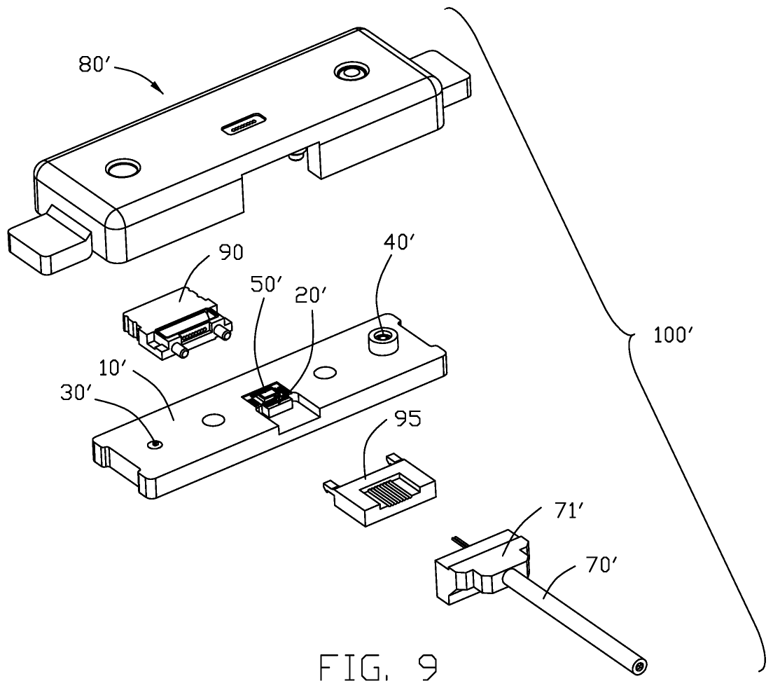

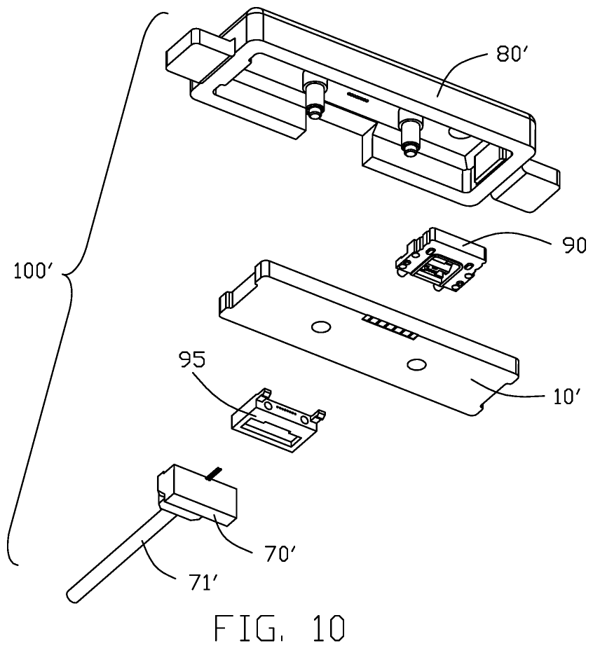

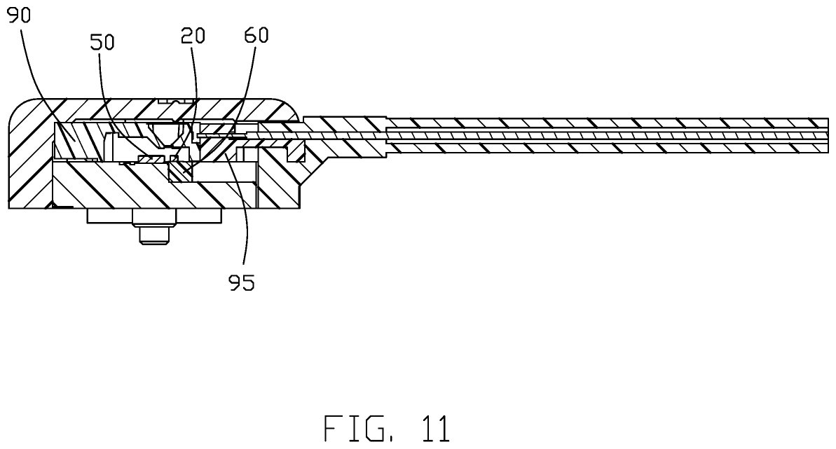

Referring to FIGS. 8-11, the second embodiment of a sensing module 100′ in accordance with the present invention is shown. Compared with the first embodiment, in this embodiment, the converter 60′ is integrated with the light emitter 20′, the content captured by the camera 40′ is transmitted to the converter 60′ through the circuit board 10′, and then converted into an optical signal and transmitted through the optical fiber 70′. In this embodiment, the sensing module 100′ further includes a first optical connector 90 and a second optical connector 95 mated with the first optical connection 90. The optical fiber 70′ is connected to the converter 60′ through the first optical connector 90 and the second optical connector 95. In other embodiments, it may also be that the converter 60 is integrated with the camera 40 and the light emitter 20.

The sensing module 100 of the present invention can also be used in other fields, such as houses, community entrances, parking lot entrances and exits, or other places that need to be monitored.

The sensing module of the present invention uses a light transmitter with low working power to continuously emit light waves to detect if there is a foreign object approaching. When there is no foreign object approaching, the light emitter with low working power will work without enabling the camera to work. When there is a foreign object approaching, the camera will work. The sensing module of the present invention is used in combination with the camera and the low-power optical transmitter, which can continuously and effectively detect changes in the surrounding environment, has low working energy consumption, long service life of the camera, and can save external storage space.

What is claimed is:

1. A sensing module comprising:
a circuit board;
a light emitter installed on the circuit board for continuously emitting light waves;
a photoelectric converter for converting emitted light waves into electrical signals;
a camera; and
a controller capable of controlling operation of the camera upon detecting that a foreign object is approaching so that light wave is reflected upon the photoelectric converter to stimulate the controller to start the camera to shoot the foreign object.

2. The sensing module as claimed in claim 1, further comprising a converter and an optical fiber connected to the converter, and wherein the converter converts the content captured by the camera into an optical signal and transmits it through the optical fiber.

3. The sensing module as claimed in claim 1, wherein the camera supports 1K and above shooting.

4. The sensing module as claimed in claim 1, wherein the working power of the light emitter is less than the working power of the camera.

5. The sensing module as claimed in claim 1, wherein the working power of the camera is at least 20 times the working power of the light emitter.

6. The sensing module as claimed in claim 2, wherein the converter is integrated with the camera.

7. The sensing module as claimed in claim 2, wherein the converter is integrated with the light emitter.

8. The sensing module as claimed in claim 1, wherein the radius sensed by the sensing module is up to 3 meters.

9. The sensing module as claimed in claim 1, further comprising a light-transmitting member covering the light emitter, the photoelectric converter, and the camera, and wherein the light-transmitting member allows transmission and reception of the light wave and the shooting of the camera.

10. The sensing module as claimed in claim 1, wherein the photoelectric converter monitors the shape of foreign objects based on the light waves reflected on it.

11. The sensing module as claimed in claim 1, further comprising a second controller that controls the operation of the light emitter and the strength of the light wave emitted by the light emitter.

12. The sensing module as claimed in claim 11, wherein the second controller is integrated with the controller.

13. The sensing module as claimed in claim 2, further comprising a first optical connector and a second optical connector mated with the first optical connection, and wherein the optical fiber is connected to the converter through the first optical connector and the second optical connector.

14. The sensing module as claimed in claim 2, wherein the converter, the camera, and the light transmitter are all integrated together.
